(19) United States
(12) Patent Application Publication
(10) Pub. No.: US 2024/0111200 A1
(43) Pub. Date: Apr. 4, 2024

(54) ELECTROLYTE FOR DURABLE DYNAMIC GLASS BASED ON REVERSIBLE METAL ELECTRODEPOSITION

(71) Applicant: The Regents of the University of Colorado, a body corporate, Denver, CO (US)

(72) Inventors: Tyler S. Hernandez, Boulder, CO (US); Michael T. Strand, Boulder, CO (US); Andrew L. Yeang, Boulder, CO (US); Michael D. McGehee, Boulder, CO (US)

(21) Appl. No.: 18/274,858

(22) PCT Filed: Jan. 29, 2021
(86) PCT No.: PCT/US2021/015851

§ 371 Date: Jul. 28, 2023

Related U.S. Application Data
(60) Provisional application No. 62/968,502, filed on Jan. 31, 2020.

(51) Int. Cl. G02F 1/1506; G02F 1/1524; G02F 1/155

(52) U.S. Cl. CPC G02F 1/1506; G02F 1/1524; G02F 1/155; G02F 2001/1555

(57) ABSTRACT

Electrochromic “smart” windows allow control of solar and heat flux through the window without sacrificing the view. Despite such appeal, traditional technologies lack the inability to simultaneously achieve fast switching with color neutral tinting and a wide optical dynamic range at low cost. Reversible metal electrodeposition (RME) addresses the drawbacks of existing metal-oxide electrochromic technologies. Several possible RME electrolytes at various pHs with different supporting anions were studied (NO₃⁻, SO₄²⁻, ClO₄, Cl⁻, Br⁻). Acidic perchlorate electrolytes work particularly well, permitting fully reversible metal electrodeposition without harming the substrate or introducing irreversible side reactions. The perchlorate electrolyte shows promising long-term durability in terms of both cycle life and shelf-life, demonstrating 10,000 stable cycles with no evidence of electrode etching. In addition, the use of this perchlorate electrolyte widens the deposition voltage window, enabling construction of relatively large area dynamic windows that tint relatively uniformly with fast, color-neutral switching at low cost.

### CROSS REFERENCE TO RELATED APPLICATIONS

The present application claims priority to and the benefit of U.S. Provisional Patent Application No. 62/968,502 filed Jan. 31, 2020, entitled “ELECTROLYTE FOR DURABLE DYNAMIC GLASS BASED ON REVERSIBLE METAL ELECTRODEPOSITION,” which application is herein incorporated by reference in its entirety.

### STATEMENT REGARDING FEDERALLY SPONSORED RESEARCH OR DEVELOPMENT

This invention was made with government support under grant number DE-EE0008226 awarded by the U.S. Department of Energy. The government has certain rights in the invention.

### BACKGROUND

Dynamic windows control both the light and heat flow in and out of buildings while maintaining the view through the glass, thus offering both energetic and aesthetic advantages over static controls such as blinds or shades. A recent study by View, Inc. and Cornell University showed that implementing dynamic windows in office buildings can improve employee productivity by up to 2% through reduced glare and optimal temperature and lighting control. In addition to the aesthetic advantages, dynamic windows can lead to an average of ˜10-20% energy savings over static low-E windows by decreasing heating, ventilation, and air conditioning (HVAC) energy consumption.

Over the past several decades, the majority of dynamic window research has focused on electrochromic conductive organic molecules and ion-intercalation based metal oxide electrochromic materials (particularly WO₃ and NiOₓ) that change color upon application of a voltage. Despite the numerous promising advantages of such windows over static lighting controls, they have yet to achieve widespread commercialization due to their inability to simultaneously provide durable long-term reliability, color-neutral operational characteristics, fast switching on a large-scale, and reasonable cost.

An exciting alternative to electrochromism is reversible metal electrodeposition (RME). Such windows operate through the reversible electrochemical movement of metal on and off a transparent conducting oxide (TCO) electrode, such as indium tin oxide (ITO) or fluorine-doped tin oxide (FTO). The electrolyte of these windows contains solubilized, nearly colorless metal cations that can be reduced upon application of a cathodic potential to the TCO to induce optical tinting.

Reversing the polarity oxidizes the metallic film back into the electrolyte, thus allowing the window to return to its initial transparent state. Pt nanoparticles adhered to the TCO surface serve as an enhanced metal nucleation seed layer to allow for uniform metal electrodeposition on a large scale without significantly affecting the transmissivity or conductivity of the electrode. To date, these windows are capable of switching between transparent and color-neutral opaque states in under a minute over thousands of cycles.

For any electrochromic “smart” window technology to show viability in the market, it must be durable enough to last at least 20-30 years without signs of degradation. Some academic research groups have employed RME for optical switching devices, but they are typically for reversible mirror, small-scale pixel display, or electronic paper applications. One of the most successful demonstrations of RME dynamic window technology relies on the reversible electrodeposition of Bi and Cu onto a Pt-nanoparticle modified TCO electrode from an aqueous, acidic, halide electrolyte. While this electrolyte and electrode exhibit promising properties for dynamic windows, including fast switching with color neutrality, the durability of this system has yet to meet the standards necessary for widespread commercialization.

### SUMMARY

The present disclosure presents a detailed systematic study of RME for dynamic window applications by varying numerous electrolytic parameters including anion selection and pH in aqueous media. The present disclosure identifies and addresses the main degradation processes hindering the durability of this technology, summarized in Table 1 below. While there have been some examples of RME in non-aqueous solvents (e.g., DMSO and ethylene glycol), and while use of such solvents is within the scope of the present disclosure, in an embodiment, the solvent is an aqueous electrolytic system, which can be advantageous because water is nontoxic and readily solvates various suitable inorganic metal salts. While numerous anions may be suitable for use, in an embodiment, the anion may be one or more of Br⁻, Cl⁻, ClO₄⁻, SO₄²⁻ or NO₃⁻. The cationic selection for the electrolytes may be any suitable counterion, such as a metal (e.g., alkali metal, alkali earth metal, transition metal). In an embodiment, the metal may include at least one of lithium or copper (e.g., Li⁺ or Cu²⁺). These cations may be particularly suitable due to their electrolytic conductivity and/or reversibility. Importantly, the RME mechanism of Cu (and potentially other metals) can vary significantly based on the anion that the metal is paired with, so the anionic choice provides insight into its durability for dynamic window applications. Both acidic and acid-free electrolytes are explored herein as a majority of electroplating baths operate at low pHs, without the addition of complexing ligands to avoid insolubility issues typically associated with basic pHs. Finally, the present disclosure focuses on RME from various aqueous electrolytes on ITO electrodes. In an embodiment, amorphous zinc-oxides may be avoided due to their instability in acid. Similarly, although fluorine-doped tin oxide (FTO) may be stable in acid, the high deposition processing temperatures for this material make it less suitable for flexible applications. That said, one advantage of using FTO in an RME dynamic window is that it can allow for the incorporation of other anions (i.e. SO₄²⁻, Cl⁻, Br) in the electrolyte, where such other anions may otherwise etch an ITO electrode. Table 1 below summarizes characteristics Applicant has observed relative to various combinations of anions in various pH environments, when using an ITO electrode.

TABLE 1
Table 1: Systematic study of degradation mechanisms (or lack thereof)
involved with 5 anions (NO₃⁻, SO₄²⁻, ClO₄⁻, Cl⁻, and Br⁻) in acid-free
and acidic aqueous electrolytes for RME dynamic window applications.

| | NO₃⁻ | SO₄²⁻ | ClO₄⁻ | Cl⁻ | Br⁻ |
|---|---|---|---|---|---|
| Acid-Free | HNO₂ | Deposition of | Deposition of | Deposition of | Br₃⁻ |
| | reduction | insoluble | insoluble Cu₂O | insoluble CuCl | oxidation |
| | | Cu₂O | complexes | complexes | coloring, |
| | | complexes | | | similar |
| | | | | | degradation |
| | | | | | to Cl⁻ |
| Acidic | HNO₂ | Rapid etching | No etching of | Slow etching of | Br₃⁻ |
| | reduction | of ITO | ITO electrode | ITO electrode | oxidation |
| | | electrode | and no | | coloring, |
| | | | formation of | | similar |
| | | | insoluble Cu | | degradation |
| | | | complexes | | to Cl⁻ |

The present disclosure thus employs electrolyte materials that provide for durability and other desired characteristics in a reversible metal electrodeposition electrochromic dynamic article (e.g., a window). Such an article may include a transparent or translucent conductive electrode (e.g., transparent conductive oxide (TCO) electrode, such as an ITO or FTO electrode), a counter electrode, and an electrolyte in contact with the transparent or translucent conductive electrode, where the electrolyte comprises cations (e.g., metal cations) that can be reversibly electrodeposited onto the transparent or translucent conductive electrode when a cathodic potential is applied to the TCO or other employed electrode. By reversing the polarity of the applied voltage, the electrodeposition is reversed, returning the metal ions or other cation back into the electrolyte solution. Such process can be repeated thousands or tens of thousands of times, where the structures of the device are durable, and able to cycle such procedure over and over again (e.g., for typical use in a window application, over a period of many years, such as at least 10 years, or 20-30 years).

The anion of the electrolyte may particularly be a perchlorate (ClO₄⁻). Applicant has advantageously found that perchlorate anions, particularly where the electrolyte is an acidic solution, exhibit excellent characteristics relative to the ability of the electrolyte to maintain solubility of components in the solution, e.g., minimizing the occurrence of side reactions, that otherwise might result in precipitation of unwanted materials, that interfere with the desired electrodeposition, and its subsequent reversal, over thousands, or tens of thousands of cycles, providing the desired durability. Such electrolytes have also been found to minimize or prevent etching of the transparent or translucent conductive electrode, which etching would also negatively affect the durability and life-span of the window or other device. While perchlorates have been found to provide such benefits, it will be appreciated that other anions, or electrolyte components may also be capable of such, and are also within the scope of the present disclosure.

An embodiment according to the present disclosure may be directed to an electrochromic dynamic glass article capable of reversible metal electrodeposition, comprising a transparent or translucent conductive electrode, an electrolyte in contact with the transparent or translucent conductive electrode, the electrolyte comprising cations (e.g., metal cations) that can be reversibly electrodeposited onto the transparent or translucent conductive electrode, and a counter electrode, where the electrolyte includes an anion selected for its ability to (i) maintain solubility of components in the electrolyte solution and (ii) minimize or prevent etching of the transparent or translucent conductive electrode. In an embodiment, the electrolyte includes perchlorate anions.

In an embodiment, the electrolyte can have an acidic pH (e.g., less than 7, less than 6, less than 5, less than 4, less than 3, or less than 2).

In an embodiment, the cations (e.g., metal cations) for reversible electrodeposition on the transparent or translucent electrode include copper.

In an embodiment, the cations can include two different metal cations, such as copper, and at least one of bismuth or lithium.

In an embodiment, the electrolyte is an aqueous electrolyte solution.

In an embodiment, the transparent or translucent conductive electrode can include metal nanoparticles (e.g., Pt nanoparticles). Such nanoparticles may be of any desired size (e.g., average diameter of less than 100, less than 50, or less than 10 nm, such as from 0.1 to 10 nm, or 1 to 5 nm.

In an embodiment, the conductive electrode is transparent (e.g., an indiumtin oxide or fluorine-doped tin oxide transparent conductive electrode).

Another embodiment is directed to an electrochromic dynamic glass article (e.g., a window) capable of reversible metal electrodeposition, comprising a transparent or translucent conductive electrode, an electrolyte solution in contact with the transparent or translucent conductive electrode, the electrolyte solution comprising cations (e.g., metal cations) that can be reversibly electrodeposited onto the transparent or translucent conductive electrode upon application of a cathodic potential. The article further includes a counter electrode, and the electrolyte solution comprises an anion, the anion being selected for its ability to (i) maintain solubility of components in the electrolyte solution and/or (ii) minimize or prevent etching of the transparent or translucent conductive electrode.

In an embodiment, the anion of the electrolyte solution can be a polyatomic anion.

In an embodiment, the polyatomic anion can include chlorine, sulfur (e.g., sulfate) and/or oxygen.

In an embodiment, the polyatomic anion can include perchlorate.

In an embodiment, the electrolyte solution is acidic (e.g., having a pH of less than 7, less than 6, less than 5, less than 4, less than 3 or less than 2).

In an embodiment, the cation includes copper.

In an embodiment, the cation (e.g., metal cation) can include two different cations (e.g., at least two of copper, bismuth, or lithium).

In an embodiment, the electrolyte solution is an aqueous solution.

In an embodiment, the transparent or translucent conductive electrode can include metal nanoparticles (e.g., Pt nanoparticles). Such nanoparticles may be of any desired size (e.g., average diameter of less than 100, less than 50, or less than 10 nm, such as from 0.1 to 10 nm, or 1 to 5 nm.

In an embodiment, the conductive electrode can be transparent (e.g., an indium tin oxide or fluorine-doped tin oxide transparent electrode).

In an embodiment, the counter electrode can include the same metal as a metal cation present in the electrolyte solution.

In an embodiment, the counter electrode can include the metal that is different than a metal cation present in the electrolyte solution.

In an embodiment, the article can include a third electrode.

In an embodiment, the electrolyte can have a deposition voltage tolerance window of at least 0.2 V, at least 0.3 V, at least 0.4 V, at least 0.5 V, or at least 0.6 V.

In an embodiment, the electrochromic dynamic glass window or other article can be configured to selectively darken within 6 minutes, within 5 minutes, within 4 minutes, or within 3 minutes of application of the cathodic potential.

In an embodiment, after darkening, the electrochromic dynamic glass window or other article returns to its initially transparent or translucent condition within 6 minutes, within 5 minutes, within 4 minutes, within 3 minutes, within 2 minutes, or within 1 minute of reversing a polarity of an applied voltage.

In an embodiment, the electrochromic dynamic glass window or other article provides a contrast ratio of at least 30%, at least 40%, at least 50%, or at least 60% between darkened and lightened conditions.

The embodiments described herein solve one or more problems of reversible metal electrodeposition, exhibiting improved durability, including high cycle life, while simultaneously exhibiting relatively fast switching with color neutral tinting and wide optical dynamic range at reasonable cost.

Features from any of the disclosed embodiments may be used in combination with one another, without limitation. For example, any of the compositional or other limitations described with respect to one embodiment may be present in any of the other described embodiments. In addition, other features and advantages of the present disclosure will become apparent to those of ordinary skill in the art through consideration of the following detailed description and the accompanying drawings.

### BRIEF DESCRIPTION OF THE DRAWINGS

FIGS. 1A-1B: 1A) Cyclic voltammograms of acid-free and acidic Li—Br⁻ electrolytes on bare ITO with a Pt counter electrode and Ag/AgCl reference electrode at a scan rate of 20 mV/s. 1B) Transmission spectra of ITO on glass substrate before and after being held at +1V to induce Br₃⁻ formation.

FIGS. 2A-2B: 2A) Cyclic voltammograms and 2B) optical response at 550 nm of acid-free Cu—Li SO₄²⁻ electrolyte before and after 1000 cycles. 3-electrode half-cell set up includes a bare ITO working electrode with a Pt counter electrode and Ag/AgCl reference electrode at a scan rate of 20 mV/s.

FIGS. 3A-3B: 3A) Cyclic voltammogram and optical response of acid-free Cu—Li Cl⁻ electrolyte on Pt-modified ITO. 3B) Cyclic voltammogram of acidic Cu—Li Cl⁻ electrode on bare ITO and Pt-modified ITO. Three-electrode half-cell set up included a Pt counter electrode and a Ag/AgCl reference electrode with a scan rate of 20 mV/s.

FIGS. 4A-4B: 4A) Cyclic voltammograms of acid-free Cu—Li Cl⁻ electrolyte on bare ITO before and after soaking the electrode in Cl⁻ electrolyte for two weeks. Three-electrode half-cell set up included a Pt counter electrode and a Ag/AgCl reference electrode with a scan rate of 20 mV/s. 4B) Cl XPS spectra of electrode surface before and after two week soak.

FIGS. 5A-5B: 5A) Cyclic voltammograms of acidic Cu—Li Cl⁻ electrolyte on bare ITO before and after 1000 cycles in acidic Cu—Li Cl⁻ electrolyte. Three-electrode half-cell set up included a Pt counter electrode and a Ag/AgCl reference electrode with a scan rate of 20 mV/s. 5B) Cu XPS spectra of electrode surface before and after 1000 cycles.

FIG. 6 shows a schematic outlining the effects of Pt and Cl⁻ on Cu electrodeposition over time and cycling in acidic Cu—Li Cl⁻ electrolyte.

FIGS. 7A-7C: 7A) Cyclic voltammograms of acidic Bi—Cu ClO₄⁻ electrolyte on Pt-ITO, 7B) Current profiles and 7C) corresponding optical response curves over the course of 10000 cycles. Three-electrode half-cell set up included a Pt counter electrode and a Ag/AgCl reference electrode with a scan rate of 20 mV/s.

FIGS. 8A-8C: 8A) Transmission vs time response at the edge and center of a 225 cm² two-electrode dynamic window containing acidic Bi—Cu—Li ClO₄⁻ electrolyte. Illustration of dynamic window in 8B) transparent and 8C) dark states. Device includes Pt-modified working electrode and Cu grid counter electrode. Optical cycling induced by applying cathodic potential of −1V for 180 seconds and +1V for 60 seconds.

FIGS. 9A-9B: 9A) Cyclic voltammograms of acidic and acid-free NO₃⁻ electrolytes containing 1M LiNO₃ and 10 mM HNO₃/1M LiNO₃, respectively, on bare ITO substrates with a Pt counter electrode and Ag/AgCl reference electrode at a scan rate of 20 mV/s. 9B) Illustration of 25 cm² 2-electrode dynamic window containing Cu—Li NO₃⁻ electrolyte after 10 cycles (showing discoloration).

FIGS. 10A-10B: 10A) Cyclic voltammograms and 10B) optical response at 550 nm of acid-free Cu—Li ClO₄⁻ electrolyte before and after 1000 cycles. 3-electrode half-cell set up includes a bare ITO working electrode with a Pt counter electrode and Ag/AgCl reference electrode at a scan rate of 20 mV/s.

FIGS. 11A-11B: 11A) Cyclic voltammograms and 11B) optical response at 550 nm of acid-free Cu—Li Cl⁻ electrolyte on Pt-modified ITO before and after 1000 cycles in acid-free Cu—Li Cl⁻ electrolyte. Three-electrode half-cell set up included a Pt counter electrode and a Ag/AgCl reference electrode with a scan rate of 20 mV/s. Optical cycling induced by applying a cathodic potential of −0.6V for 60 s followed by anodic potential of +0.8V for 20 s.

FIG. 12: Pt XPS spectra of Pt-modified ITO electrode surface before and after 1000 cycles in acid-free Cu—Li Cl⁻ electrolyte.

FIG. 13: Cyclic voltammograms of acid-free Cu—Li Cl⁻ electrolyte before and after 1000 cycles. 3-electrode half-cell set up includes a bare ITO working electrode with a Pt counter electrode and Ag/AgCl reference electrode at a scan rate of 20 mV/s.

FIG. 14: Cyclic voltammograms of acidic Cu—Li Cl⁻ and ClO₄⁻ electrolyte. 3-electrode half-cell set up includes a Pt-modified ITO working electrode with a Pt counter electrode and Ag/AgCl reference electrode at a scan rate of 20 mV/s.

FIGS. 15A-15B: 15A) Cyclic voltammograms and 15B) optical response of acidic Cu—Li ClO₄⁻ electrolyte on Pt-modified ITO on the 1st, 1000th, and 5000th cycle. Three-electrode half-cell set up included a Pt counter electrode and a Ag/AgCl reference electrode with a scan rate of 20 mV/s. Optical cycling induced by applying a cathodic potential of −0.6V for 60 s followed by anodic potential of +0.8V for 20 s.

FIG. 16 shows four-point probe sheet resistance measurements of bare ITO electrode soaking in acidic Cl⁻ and acidic ClO₄⁻ electrolytes over the course of one month.

FIG. 17A-17B shows the etching mechanism (or lack thereof) of Indium Tin Oxide (ITO) electrode by aqueous, acidic 17A) chloride and 17B) perchlorate solutions.

FIG. 18: Cyclic voltammograms of acidic Li Cl⁻ and acidic Li ClO₄⁻ electrolytes on bare ITO. Three-electrode half-cell set up includes a Pt counter electrode and a Ag/AgCl reference electrode with a scan rate of 20 mV/s.

FIGS. 19A-19D: Transmission of Pt-modified ITO electrode in 19A) acidic Cu—Li ClO₄⁻ electrolyte and 19B) acidic Bi—Cu—Li ClO₄⁻ electrolyte. Reflection of Pt-modified ITO electrode in 19C) acidic Cu—Li ClO₄⁻ electrolyte and 19D) acidic Bi—Cu—Li ClO₄⁻ electrolyte. Three-electrode half-cell set up included a Pt counter electrode and a Ag/AgCl reference electrode. Optical tinting induced by applying cathodic potential of −0.7 V for 30, 60, and 180 seconds.

FIG. 20: Scanning Electron Microscope Image of Bi—Cu deposits from acidic ClO₄⁻ electrolyte on Pt-modified ITO substrate. Deposits were formed by applying cathodic potential of −0.7V for 60 seconds.

FIG. 21: Cyclic voltammograms of acidic Li ClO₄⁻ electrolyte on bare ITO scanned to different cathodic potentials. Three-electrode half-cell set up includes a Pt counter electrode and a Ag/AgCl reference electrode with a scan rate of 20 mV/s.

FIGS. 22A-22B: 22A) Transmission versus time curves for switching at a series of deposition voltages. Each set of curves represents electrodeposition at different voltages from −200 to −900 mV. Deposition was performed for 30 s followed by a 30 s stripping sequence at +1 V. 22B) Graph of maximum length of uniformly switching RME dynamic window as a function of electrolytic deposition voltage tolerance window.

FIG. 23: COMSOL model showing a voltage drop from edge to center of a 15×15 cm (225 cm²) Pt-modified ITO working electrode in the Bi—Cu acidic ClO₄⁻ electrolyte.

The drawings and figures are not necessarily drawn to scale, unless otherwise indicated, but instead are drawn to provide a better understanding of the components, and are not intended to be limiting in scope, but to provide exemplary illustrations.

### DETAILED DESCRIPTION OF VARIOUS EMBODIMENTS

To further clarify the above and other advantages and features of the present disclosure, a more particular description will be rendered by reference to specific embodiments thereof, which are illustrated in the appended drawings. It is appreciated that these drawings depict only typical embodiments of the disclosure and are therefore not to be considered limiting of its scope. The present disclosure will be described and explained with additional specificity and detail through the use of the accompanying drawings, in which like reference characters refer to like elements.

It is to be understood that disclosure is not limited to the specific embodiments and methods described below, as specific components and/or conditions may, of course, vary. Furthermore, the terminology used herein is used only for the purpose of describing particular embodiments and is not intended to be limiting in any way.

Except in the examples, or where otherwise expressly indicated, all numerical quantities in this description indicating amounts of material or conditions of reaction and/or use are to be understood as modified by the word “about” in describing the broadest scope of the disclosure. Also, unless expressly stated to the contrary: description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation; and, unless expressly stated to the contrary, measurement of a property is determined by the same technique as previously or later referenced for the same property.

It must also be noted that, as used in the specification and the appended claims, the singular form “a,” “an,” and “the” may comprise plural references unless the context clearly indicates otherwise. For example, reference to a component in the singular is intended to comprise a plurality of components.

The present disclosure is directed to use of electrolyte materials that provide for durability and other desired characteristics in a reversible metal electrodeposition electrochromic dynamic article (e.g., a window). Such an article may include a transparent or translucent conductive electrode (e.g., a transparent conductive oxide (TCO) electrode, such as an ITO or FTO electrode), a counter electrode, and an electrolyte in contact with the transparent or translucent conductive electrode, where the electrolyte comprises cations (e.g., metal cations) that can be reversibly electrodeposited onto the transparent or translucent conductive electrode. By reversing the polarity of the voltage applied between the electrodes, the process is reversible, allowing one to darken (and subsequently re-lighten) such a window or other device.

The anion of the electrolyte may be specifically selected so as to (i) maintain solubility of components in the electrolyte solution and (ii) minimize or prevent etching of the transparent or translucent conductive electrode. In an embodiment, the anion of the electrolyte may particularly include perchlorate (ClO₄⁻) ions. Applicant has advantageously found that perchlorate anions, particularly where the electrolyte is an acidic solution, exhibit excellent characteristics relative to the ability of the electrolyte to maintain solubility of components in the solution, e.g., the absence of side reactions, that otherwise might result in precipitation of unwanted materials, that interfere with the desired electrodeposition, and its subsequent reversal, over thousands, or tens of thousands of cycles, providing the desired durability. Such electrolytes have also been found to minimize or prevent undesirable etching of the transparent or translucent conductive electrode, which etching would also negatively affect the durability and life-span of the window or other device. While perchlorates have been found to provide such benefits, it will be appreciated that other anions, or electrolyte components may also be capable of such, and are also within the scope of the present disclosure. For example, additional such anions could be identified using techniques similar to as described herein, by which perchlorate was identified as a suitable anion. By way of further example, anions not particularly suitable for use with an ITO electrode (e.g., Br, Cl⁻, SO₄²⁻ NO₃⁻ or any of numerous others) may be suitable with another TCO electrode (e.g., such as an FTO electrode).

### EXPERIMENTAL

The following experimental examples are provided to illustrate embodiments of the current disclosure and to more particularly demonstrate the advantages of the embodiments but are not intended to limit the scope thereof.

Chemicals were received from commercial sources and used without further purification. Electrochemical studies were carried out using a SP-150 Biologic potentiostat. For experiments employing three electrodes, electrochemical potentials were measured and reported with respect to a “no-leak” Ag/AgCl (3 M KCl) reference electrode (eDAQ). Cyclic voltammograms were performed using a scan rate of 20 mV/s. Electrodes with a sheet resistance of 10 Ω/sq including ITO on glass (Xinyan Technology Ltd.) were cleaned by successively sonicating in de-ionized H₂O with 10% Extran solution for 10 min, acetone for 5 min, and isopropanol for 10 min. The electrodes were subsequently dried under a stream of N₂. The electrodes were then placed in a UVO-cleaner (Jelight Company Inc, Model No 42) for 10 mins for subsequent cleaning. Pt nanoparticles (Sigma-Aldrich) used to modify the working electrodes had average diameters of 3 nm. After cleaning, the ITO substrates were immersed in a solution of 3-mercaptopropionic acid (10 mM in ethanol) for 24 hours. The electrodes were next rinsed with ethanol and H₂O before they were immersed for at least 24 hours in the Pt nanoparticle dispersion that was diluted 1:4 with H₂O. Lastly, ITO on glass substrates were annealed in air at 250° C. for 20 minutes before use.

Dynamic windows were constructed in either three-electrode or two-electrode configurations. Three-electrode devices employed Pt-modified ITO on glass working electrode, a Pt wire counter electrode, and a Ag/AgCl reference electrode. The immersed geometric surface area of the working electrode was 1.0 cm², and spectroelectrochemical cells were assembled in a 4.5 cm by 2.0 cm by 1.0 cm glass cuvette (G205, Labomed, Inc.). The aqueous, acid-free electrolytes included 10 mM CuX and 1M LiX (where X=the tested anion, such as Br⁻, Cl⁻, ClO₄⁻, SO₄²⁻, or NO₃⁻). The aqueous, acidic electrolytes contained an additional 10 mM HX (X═Br⁻, Cl⁻, ClO₄⁻, SO₄²⁻, NO₃⁻).

Two-electrode dynamic windows employed 225 cm² Pt-modified ITO on glass working electrodes. Transparent Cu mesh (TWP, Inc., wire diameter: 0.0012 in) served as both the counter and reference electrodes in the 225 cm² two-electrode device. The electrolyte for the large-scale window contained an additional 10 mM BiOClO₄ for color neutrality. Butyl rubber Solargain edge tape with a thickness of 2 mm and a width of 5 mm (Quanex Inc.) separated the two device electrodes and retained the electrolyte within the device. Carbon tape with conductive adhesive (ElectricMosaic, Z22) was used to make electrical contact to the working electrode.

Transmission spectra were measured with an Ocean Optics USB2000 spectrometer coupled with an Ocean Optics halogen light source (HL-2000-FHSA). XPS was performed using a PHI Versaprobe 1 equipped with Ar sputtering for depth profiling. SEM was performed using a FEI Nova NanoSEM 630.

### Results/Discussion

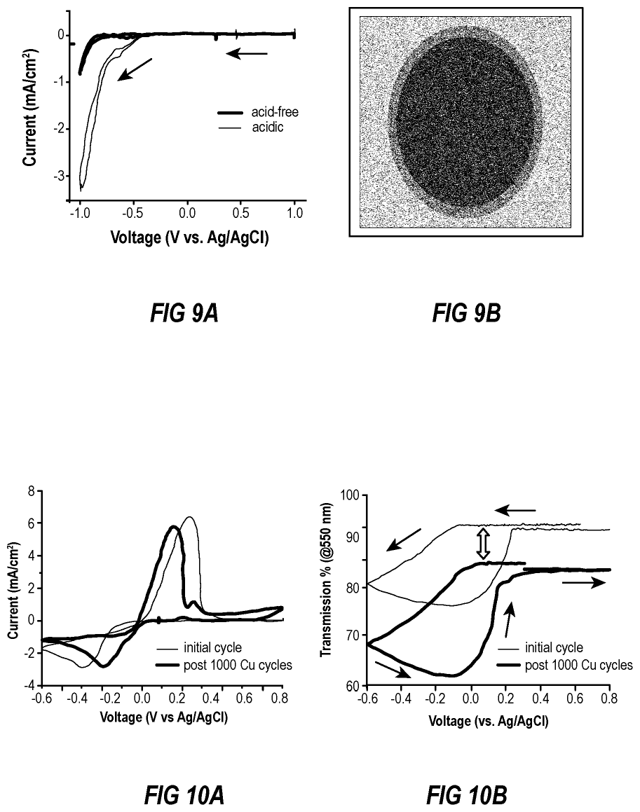

Nitrates (NO₃⁻) are common anions used in aqueous electrolytes for electrochemical deposition as metal salts with these anions are typically readily soluble in aqueous media. However, this anion shows irreversibility issues for RME dynamic window applications. Cyclic voltammograms of acidic and acid-free Li—NO₃⁻ electrolytes without Cu show a rise in cathodic current beyond −0.5 V, which is due to the reduction of NO₃⁻ to NO₂⁻ (FIG. 9A). Upon subsequent scanning in the anodic direction, there is no corresponding oxidative peak. Thus, the absence of a complete redox couple indicates that aqueous electrolytes containing NO₃⁻ anions exhibit irreversible reduction at cathodic potentials needed for uniform, diffusion limited plating of Cu on a large scale. This degradation becomes apparent when making a 2-electrode dynamic window with a Cu—Li—NO₃⁻ electrolyte and noting that irreversible deposits, most likely comprised of Cu(NO₂)ₓ^{y-} complexes, are left on the working electrode surface after a few cycles (FIG. 9B). Figure S1B of the provisional application shows an actual photograph, rather than the illustration shown in FIG. 9B.

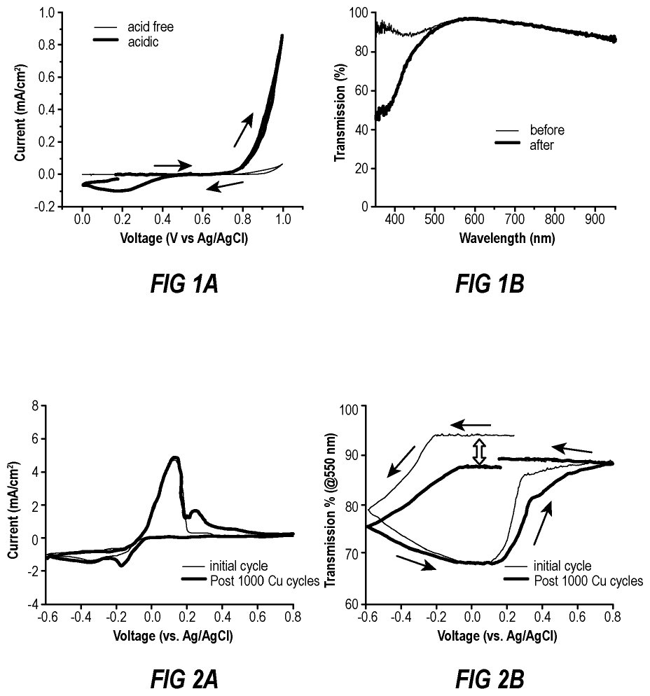

Bromides (Br⁻) are also very common supporting anions in the RME-based electrochromic community due to the ability to oxidize to Br₃⁻. This electrochemical reaction is characteristic of Br-containing electrolytes and can act as a suitable counter reaction to metal electrodeposition on the opposing electrode, which is commonly referred to as a redox shuttle. Cyclic voltammograms of acidic and acid-free Li—Br electrolytes without Cu show a rise in anodic current beyond +0.8V, which is due to the oxidation of Br⁻ to Br₃⁻ (FIG. 1A). Despite the promising advantages of having an inherent redox shuttle in the electrolyte, the oxidized Br₃⁻ complex is yellow in color (FIG. 1B). This is deemed unsuitable for RME dynamic window applications as the transparent state of these RME devices will slowly turn yellow in color after extensive cycling.

After confirming that there are no degradative electrochemical reactions from the supporting anion, the next step is to assess the RME cycling durability of various electrolytes containing Cu and Li. While aqueous electrolytes containing SO₄²⁻ anions do not exhibit any irreversible electrochemical breakdown from the supporting anion, they still result in degradation. Acid-free SO₄²⁻ will lead to irreversible Cu electroplating over time. Cyclic voltammograms of an acid-free Cu—Li—SO₄²⁻ electrolyte on ITO before and after 1000 cycles show an appearance of a second redox couple with a reductive peak at −0.2V and a corresponding oxidative peak at +0.25V (FIG. 2A). This redox couple is most likely due to the formation of insoluble Cu₂O(s), as predicted by the Pourbaix diagram of Cu. This insoluble Cu₂O causes the maximum transmission of the ITO electrode to decay over the course of 1000 cycles, specifically from ˜94% to ˜87% at 550 nm (FIG. 2B).

Acid-free Cu—Li—ClO₄⁻ electrolytes perform similarly to acid-free SO₄²⁻ ones, in that a second redox couple appears after extensive cycling (FIG. 10A). Like the SO₄²⁻ electrolytes, the second redox couple is most likely due to the formation of insoluble Cu₂O(s) complexes at more neutral pHs, which causes the maximum transmission of the ITO electrode to decrease from ˜93% to ˜85% at 550 nm after 1000 cycles (FIG. 10B). This degradation in maximum transmission deems both acid-free SO₄²⁻ and ClO₄⁻ electrolytes unsuitable for highly durable RME dynamic window applications, at least when used with the tested ITO electrode.

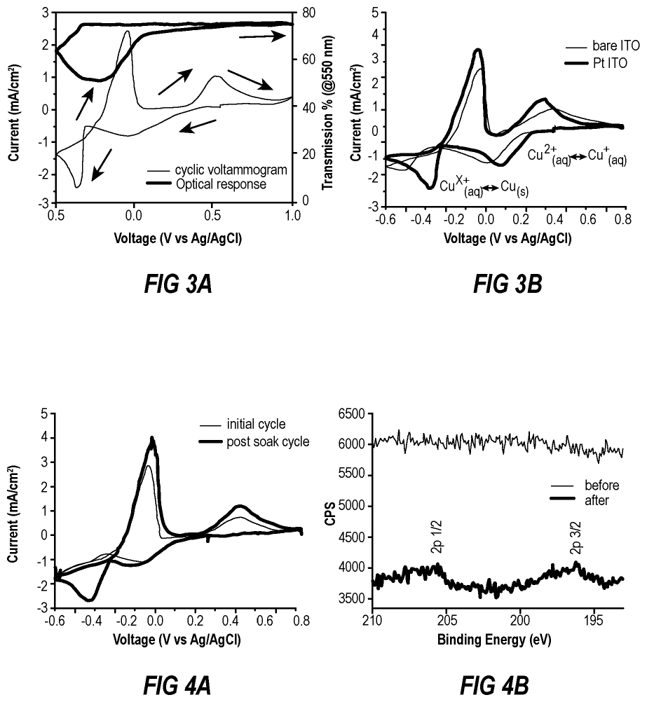

Chlorides (Cl⁻) are commonly used as additives in Cu electroplating baths to aid with electrodeposition and stripping. Cl⁻ alters the reduction of Cu²⁺_{(aq)}→Cu₍ₛ₎ by inducing a single electron transition from Cu²⁺_{(aq)}→Cu⁺_{(aq)}→4 Cu₍ₛ₎. This single electron transition is possible due to the strong reducing nature of the Cl⁻ anion, which is able to stabilize the monovalent Cu⁺ state. Spectroelectrochemical half-cell measurements confirm this mechanism because a second redox couple appears (FIG. 3A, thin line) yet there is no change in transmission of the ITO electrode over these potentials (FIG. 3A, thick line). Pt also has a strong effect on Cl⁻ electrolytic systems. In addition to improving the metal nucleation, Pt catalyzes the Cu²⁺_{(aq)}→Cu⁺_{(aq)} transition, which can be noted by a decrease in the redox couple's overpotentials (FIG. 3B).

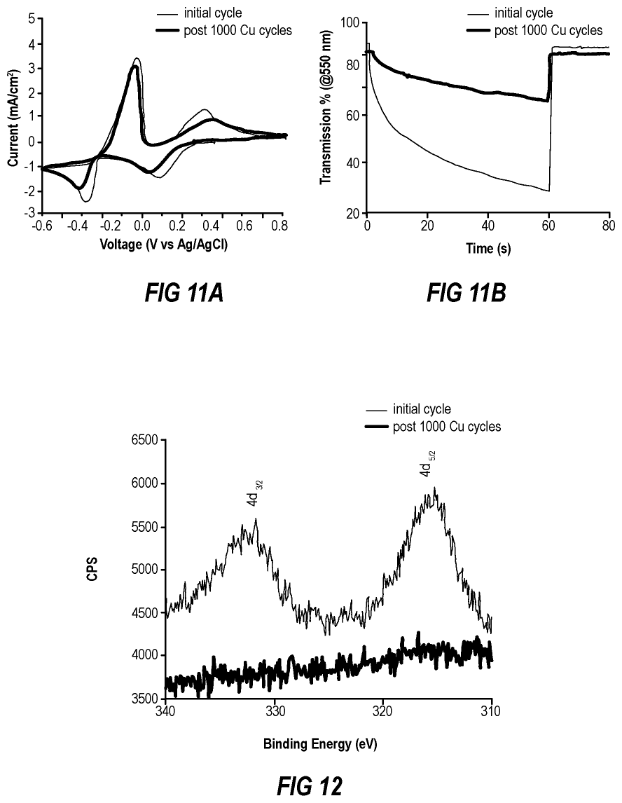

The acid-free Cl⁻ electrolyte degrades the optical performance by RME of the Pt ITO electrode after extensive cycling. The magnitude of the current density decreases after 1000 cycles for both the Cu²⁺_{(aq)}→Cu⁺_{(aq)} redox couple and the metal nucleation reduction peak (FIG. 11A). Additionally, the contrast ratio of the Pt ITO electrode significantly degrades from ˜60% to ˜20% over the course of this cycling (FIG. 11B). Both results indicate that the Pt enhancement is deteriorating, which was further confirmed by XPS analysis (FIG. 12). Finally, the maximum transmission of the ITO electrode decays from ˜90% to ˜85% at 550 nm after cycling, which is most likely attributed to insoluble metal halide complexes left behind on the electrode's surface. Taken together, these results indicate that aqueous, acid-free Cl⁻ electrolytes are unsuitable for highly durable RME dynamic window applications, at least when using the tested ITO electrode.

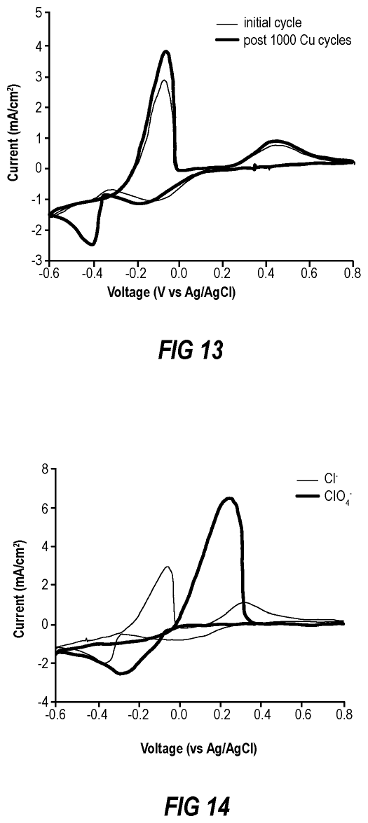

It was initially hypothesized that irreversibly electroplated Cu accumulated on the electrode during cycling, which would block the Pt nanoparticles and decrease their ability to act as nucleation sites. An improvement in metal nucleation after 1000 cycles on a bare ITO electrode (FIG. 13) supports this hypothesis because metal is a preferred nucleation site compared to ITO. However, by soaking a bare ITO electrode in an acidic Cl⁻ electrolyte without Cu and Li, the metal nucleation and growth drastically improves as noted by a decrease in the overpotential and an increase in the TAFEL slope of the metal electrodeposition peak (FIG. 4A). This is due to the adsorption of Cl⁻, which improves metal nucleation, on the electrode surface. The adsorption of Cl⁻ was confirmed by performing XPS on fresh and post Cl⁻ soaked ITO electrodes (FIG. 4B). Thus, Cl⁻ is likely blocking the active Pt sites and degrading the electrode's performance.

After deeming that acid-free electrolytes are not suitable in durable RME dynamic windows, HX acid is added to the electrolytic composition to lower the pH and avoid the irreversible metal complexes formed at more neutral pHs. Acidic SO₄²⁻ electrolytes etch the ITO surface at a very high rate, which can be noted from a rise in sheet resistance of the electrode after one week of soaking in an acidic SO₄²⁻ electrolyte without Cu and Li, from 8 Ω/sq to 33 Ω/sq. This etching eventually leads to slower switching and non-uniform plating of a 2-electrode RME dynamic window in as little as one week.

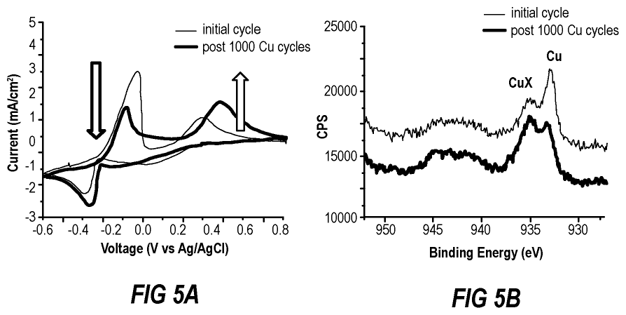

There are no indications of electrode etching or rise in sheet resistance after one week of soaking in acidic Cl⁻ and ClO₄⁻ electrolytic baths without Cu and Li. However, the acidic Cl⁻ electrolyte does indeed exhibit irreversibility issues with the reversible electrodeposition of Cu over extensive cycling. There are additional indications of Cl-adsorption when subjecting a Pt ITO electrode to extensive cycling in an acidic Cu—Li—Cl⁻ electrolyte. There is a change in the magnitude of the oxidative peaks on a Pt ITO electrode in an acidic Cu—Li—Cl⁻ electrolyte before and after extensive cycling (FIG. 5A). Specifically, the current density of the metal stripping peak decreases while the Cu⁺_{(aq)}→Cu²⁺_{(aq)} peak increases. To better understand this phenomenon, XPS analysis of the metal deposition was performed on an initial and post cycled Pt ITO electrode (FIG. 5B). The results indicate that the ratio of CuX:Cu increases after extensive cycling. This confirms that the change in the magnitude of the current density of the oxidative peaks is due to the preferential deposition of CuCl complexes over pure metallic Cu.

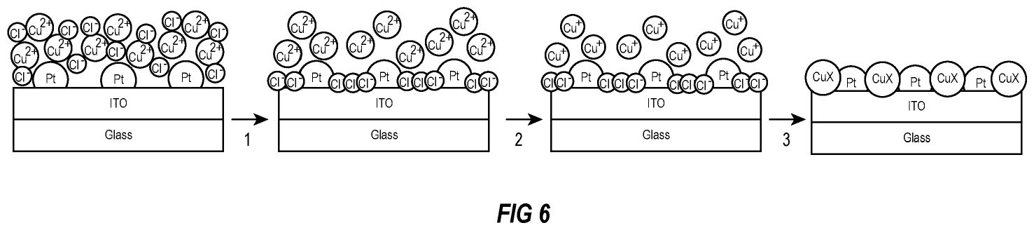

FIG. 6 summarizes the degradative process of acidic Cl⁻ electrolytes on Pt ITO electrodes. First, Cl⁻ gradually adsorbs to the ITO surface over time. Additionally, Pt will catalyze the formation of monovalent Cu⁺_{(aq)} over extensive cycling. Taken together, after long resting and cycling, CuCl complexes will preferentially nucleate on the surface over pure metallic Cu.

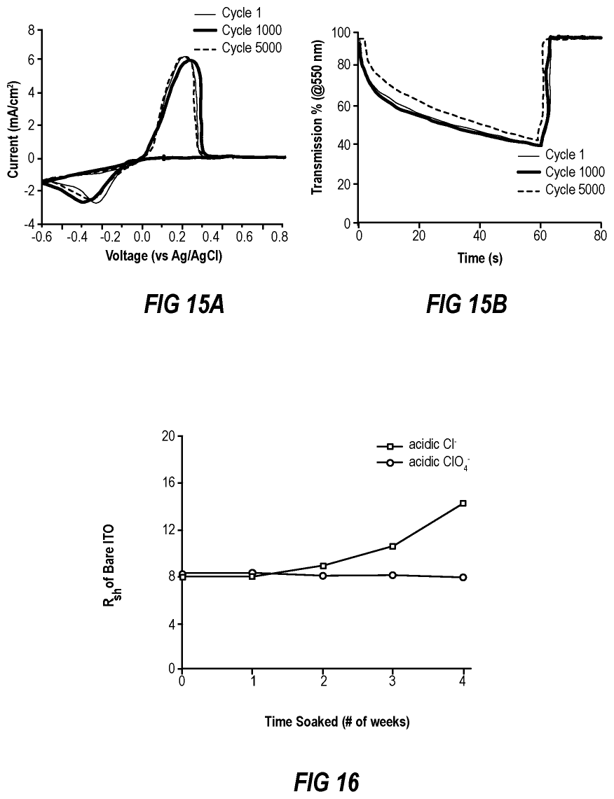

Perchlorates (ClO₄⁻) are interesting polyatomic anions used in aqueous electrolytes because they do not stabilize Cu⁺ electrodeposition and stripping intermediates, due to their weak coordinating nature (FIG. 14). This difference is important because this anion avoids the degradation previously discussed with Cu⁺_{(aq)}. The acidic ClO₄⁻ electrolyte demonstrates good reversibility over extensive cycling and shows promise for durable RME dynamic window applications (FIGS. 15A-15B).

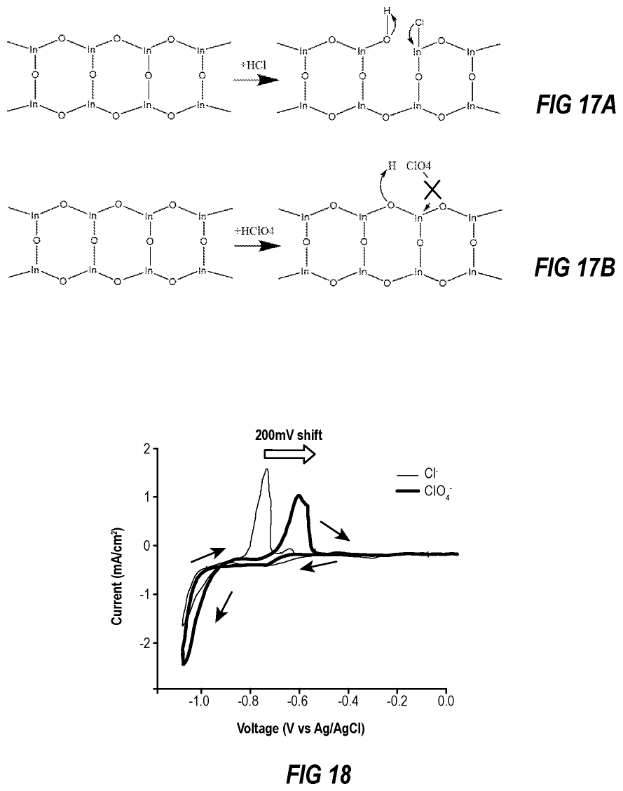

When testing RME dynamic window resting stability beyond one week, the acidic ClO₄⁻ electrolyte shows very promising characteristics for durable RME dynamic window applications. Specifically, the acidic ClO₄⁻ electrolyte does not etch the ITO surface, even after the course of one month (FIG. 16). In contrast, this stability was not seen in the Cl⁻ electrolyte. The stability of ITO in the ClO₄⁻ electrolyte is extremely valuable because it allows RME dynamic windows with ClO₄⁻ electrolytes to have a long shelf life. The degradation of ITO in the Cl⁻ electrolyte is due to etching of In₂O₃ by acidic HX (e.g., HCl) in the electrolyte, eventually resulting in the dissolution of In³⁺ and thus etching of the electrode surface. This can be described by the following reaction: In₂O₃+6HX→2InX₃+3H₂O. The first step in this etching mechanism involves the breaking of In—O and H—X bonds and the formation of In—X and H—O bonds (FIG. 17A). However, if the anion (X) has weak nucleophilic nature, such as ClO₄⁻, then it is possible to prevent the formation of In—X bond and thus inhibit the etching reaction mechanism (FIG. 17B). Other anions exhibiting a similar weak coordinating nature, so as to be stable under similar conditions may also be suitable for use, and are within the scope of the present disclosure.

Electrochemical techniques can provide further insight into this etching reaction mechanism. Cyclic voltammograms of a bare ITO electrode in acidic Cl⁻ and ClO₄⁻ electrolytes without Cu show an increase in reductive current when scanning to −1 V in the cathodic direction (FIG. 18). The initial increase in reductive current at −0.6 V is due to the adsorption of H⁺ and subsequent formation of H_{2(g)}. Beyond −0.9 V, the reduction of In and Sn occurs, and the anodic scan gives rise to oxidative peaks, which are associated with the re-oxidation of In and Sn. However, the onset potential of In oxidation shifts ˜200 mV in the positive direction when subjected to the ClO₄⁻ electrolyte compared to the Cl⁻ electrolyte. This increase in overpotential for In oxidation signifies that it is more thermodynamically favorable to oxidize In in Cl⁻ compared to ClO₄⁻ electrolytes, which explains why acidic ClO₄⁻ electrolytes do not significantly etch ITO. It will be apparent that Cl⁻ or other anions may be suitable for use with alternative TCO electrodes, e.g., an FTO electrode, that does not exhibit the above noted issues relative to In. Such embodiments are within the scope of the present disclosure.

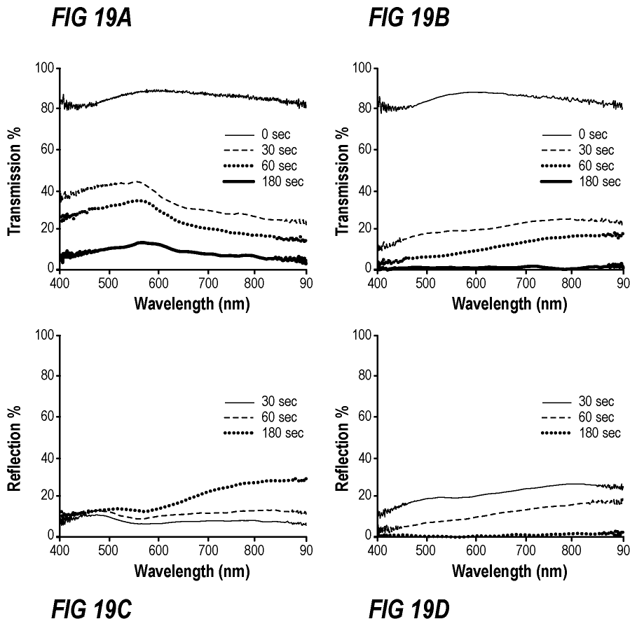

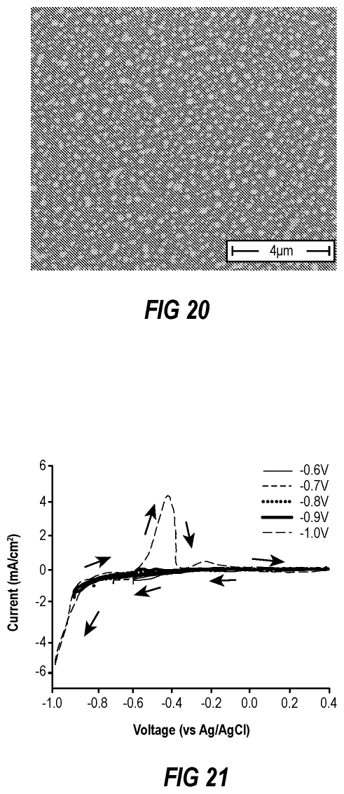

RME dynamic windows preferably demonstrate both high durability and color neutral, fast switching on a large-scale for potential implementation in fenestration applications. Improved color neutrality and faster switching can be achieved by the addition of a second metal (e.g., Bi) to the electrolyte. Pb was immediately ruled out due to toxicity concerns. Ag is a common metal used in RME electrolytes, but it is typically explored in non-aqueous solvents for reversible mirror applications. When adding 10 mM AgClO₄ to the acidic Cu—Li ClO₄⁻ electrolyte, one can note the large difference (˜500 mV) in deposition peaks between Ag and Cu. Since Ag is much more noble than Cu, Cu²⁺ ions will be unable to galvanically displace any Ag metal that is potentially left behind on the surface of the ITO or other TCO electrode. This issue becomes apparent when cycling this acidic Ag—Cu ClO₄⁻ electrolyte as the maximum transmission decays significantly over the course of 10 cycles. Bi is a much more suitable option for a secondary metal because any unoxidized Bi metal can be galvanically displaced by Cu² ions already present in the electrolyte. This bimetallic system induces a flat, color neutral optical response across the visible spectrum as compared to the Cu-only system that shows significant absorption around 650 nm, which is typically associated with the red color of Cu (FIGS. 19A-19B). Furthermore, this Bi—Cu system induces preferential absorption over reflection as more metal is plated (FIGS. 19C-19D), which is believed to be due to light scattering and absorption from the varying metal deposit particle sizes (FIG. 20).

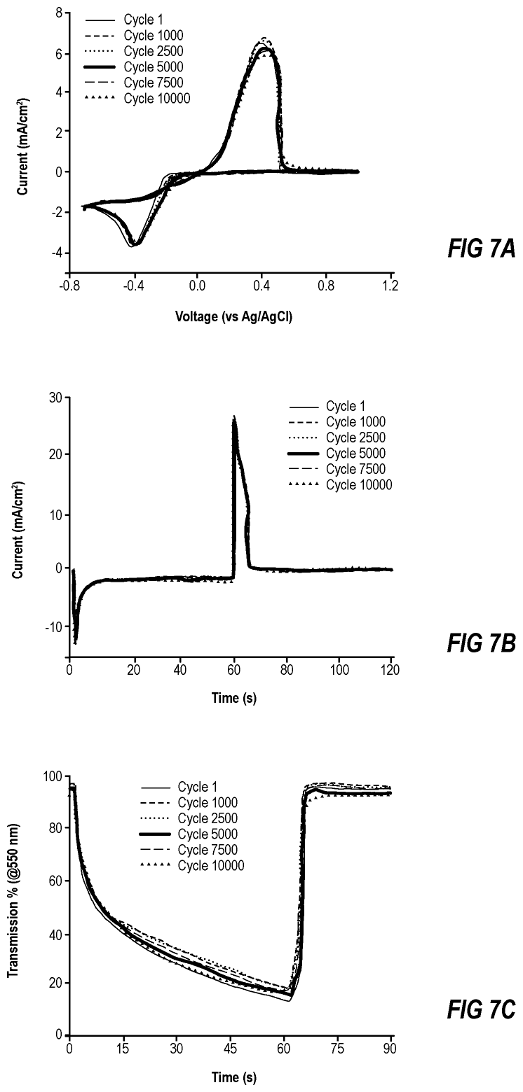

Additionally, this acidic Bi—Cu ClO₄⁻ electrolyte can achieve this absorptive, color-neutral tinting at a fast rate over thousands of cycles. By applying a cathodic potential of −0.7 V to the Pt-modified ITO electrode in the acidic Bi—Cu ClO₄⁻ electrolyte, the electrode can achieve >80% contrast in one minute and switch back to its initial transparent state in <5 seconds, after applying an anodic potential of +1 V. Optical switching is stable over the course of 10,000 electrochromic cycles (FIGS. 7A-7C). Some metal may potentially be left behind on the surface over extensive cycling, which accounts for the slight decrease in maximum transmission of the Pt-ITO electrode after 10,000 cycles.

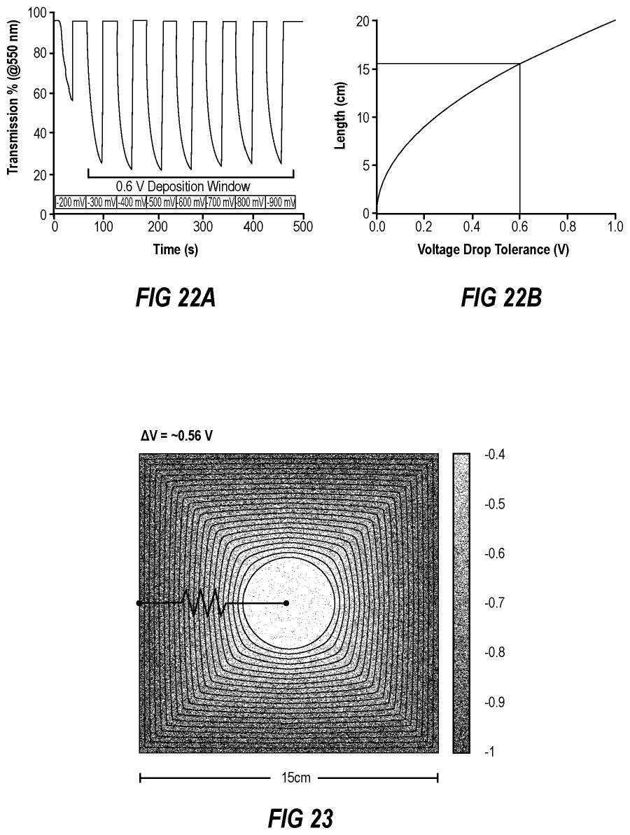

Finally, it is desirable that the bimetallic Bi—Cu ClO₄⁻ electrolyte be capable of switching uniformly when implemented into a practical, large-scale two-electrode dynamic window. RME dynamic windows can switch uniformly as long as the deposition voltage tolerance window for the electrolyte is larger than the voltage drop that will occur from the edge to the center of the TCO working electrode when optical tinting is induced. The deposition voltage tolerance window for the electrolyte is determined by the range of voltages where consistent optical contrast will occur without significant degradative side reactions. Beyond a cathodic potential of −0.9 V, the ITO electrode experiences irreversible In/Sn reduction and re-oxidation (FIG. 21). By using a 3-electrode spectroelectrochemical half-cell set up and varying the potential applied to the ITO electrode in the acidic Bi—Cu ClO₄⁻ electrolyte, the contrast ratio from metal deposition remains consistent from −0.9 V to −0.3 V. For example, at about −0.2 V it decreases due to insufficient metal plating (FIG. 22A). Thus, the acidic Bi—Cu ClO₄⁻ electrolyte has a deposition voltage tolerance window of 0.6 V.

Using a 2D integration model of Ohm's Law, the electrode's sheet resistance, and the plating current density, one can determine the theoretical maximum length of a RME dynamic window that will tint uniformly based on the electrolyte's deposition voltage tolerance window (FIG. 22B). Based on this model, this acidic Bi—Cu ClO₄⁻ electrolyte will plate uniformly on a 15×15 cm (225 cm²) RME dynamic window (FIG. 23). Larger windows may be possible when using improved electrodes and/or by slowing down the switching, which decreases the plating current density, to reduce the voltage drop in the electrodes. It may also be possible to form a larger window by arranging an array or matrix of such smaller window grids, adjacent to one another.

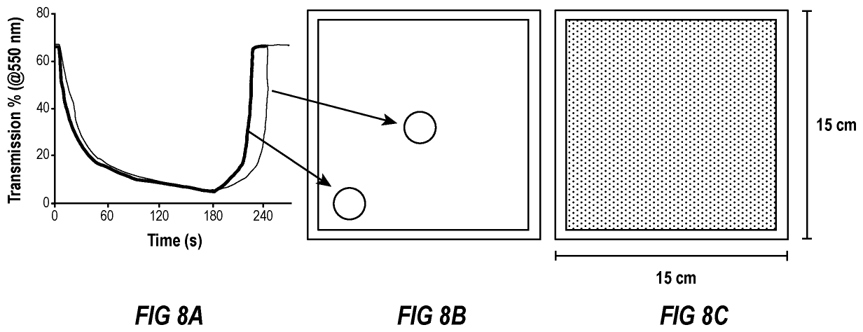

Finally, we constructed a 225 cm² (15×15 cm) RME dynamic window that exhibits fast, reversible, uniform, and color-neutral tinting. This two-electrode device can switch substantially uniformly on a 225 cm² scale with a contrast ratio >60%, darkening in <3 minutes and returning to transparent in <1 minute (FIG. 8A-8C).

Improvements to the counter electrode design may be important to achieving high durability in large-scale RME dynamic windows. The counter electrode used here included Cu (e.g., a Cu mesh), which is one of the active metals being reversibly electroplated and thus may experience heterogeneous, non-uniform plating and stripping over extensive cycling. Such may cause increased light blockage and eventual grid breakage, thus rendering the cycled counter electrode inadequate. A potentially promising counter electrode design may include a protective layer over the exposed Cu metal or a grid comprising a more noble metal, such as Pt or Au. Other electrode materials may also be used (e.g., various other conductive transition metals (e.g., Ni), including oxides thereof (e.g., NiO).

As discussed herein, in an embodiment, the electrolyte may not include (i.e., is void of) the anions noted above found to have various problems (e.g., NO₃⁻, SO₄²⁻, Cl⁻, and Br⁻), at least when paired with an ITO electrode. It will be appreciated that some embodiments may include such anions, e.g., where such problems are addressed (e.g., when using a different TCO, such as a fluorine-doped tin oxide electrode). Perchlorate (ClO₄⁻) is an example of a particularly suitable polyatomic anion to use in aqueous electrolytes for RME dynamic windows. This anion does not etch the ITO surface, which allows for the design of robust dynamic windows with long shelf lives. In an embodiment, the cation may be any of various suitable metals. By way of non-limiting example, the testing conducted herein shows that inclusion of Bi and Cu in the electrolytic system can achieve 10,000 stable electrochromic cycles, and that relatively large-scale RME dynamic windows can be provided, characterized by fast, uniform switching with high contrast and color neutrality. Such represent significant advances towards achieving widespread commercialization of practical, durable dynamic windows based on reversible metal electrodeposition.

In addition to use within fenestration (i.e., window) applications, the present disclosure can also be implemented in transition sunglasses, clear-to-black monitors or other displays, adjustable shutters, IR modulators, and the like.

Additives that may be included in the electrolyte solution are disclosed in the inventors' U.S. Provisional Application No. 63/104,975, filed Oct. 23, 2020, and entitled “ELECTROLYTE ADDITIVE FOR CONTROLLING MORPHOLOGY AND OPTICS OF REVERSIBLE METAL FILMS” which is herein incorporated by reference in its entirety.

The present disclosure can be embodied in other specific forms without departing from its spirit or essential characteristics. Thus, the described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An electrochromic dynamic glass article capable of reversible metal electrodeposition, comprising:
a transparent or translucent conductive electrode;
an electrolyte in contact with the transparent or translucent conductive electrode, the electrolyte comprising metal cations that can be reversibly electrodeposited onto the transparent or translucent conductive electrode; and
a counter electrode;
wherein the electrolyte comprises an anion selected for its ability to (i) maintain solubility of components in the electrolyte and (ii) minimize or prevent etching of the transparent or translucent conductive electrode.

2. The article as recited in claim 1, wherein the electrolyte comprises perchlorate anions.

3. The article as recited in claim 1, wherein electrolyte is acidic.

4. (canceled)

5. The article as recited in claim 1, wherein the metal cations comprise Cu.

6. (canceled)

7. The article as recited in claim 1, wherein the metal cations comprise Cu and at least one of Bi or Li.

8. The article as recited in claim 1, wherein the electrolyte is an aqueous electrolyte solution.

9. The article as recited in claim 1, wherein the transparent or translucent conductive electrode comprises Pt nanoparticles.

10. (canceled)

11. The article as recited in claim 1, wherein the transparent or translucent conductive electrode comprises a transparent conducting oxide electrode which comprises at least one of indium tin oxide or fluorine-doped tin oxide.

12. (canceled)

13. An electrochromic dynamic glass article capable of reversible metal electrodeposition, comprising:
a transparent or translucent conductive electrode;
an electrolyte solution in contact with the transparent or translucent conductive electrode, the electrolyte solution comprising metal cations that can be reversibly electrodeposited onto the transparent or translucent conductive electrode upon application of a cathodic potential; and
a counter electrode;
wherein the electrolyte solution further comprises an anion, the anion being selected for its ability to (i) maintain solubility of components in the electrolyte solution and (ii) minimize or prevent etching of the transparent or translucent conductive electrode.

14. The article as recited in claim 13, wherein the anion of the electrolyte solution comprises a polyatomic anion.

15. The article as recited in claim 14, wherein the polyatomic anion comprises chlorine or sulfate.

16. The article as recited in claim 14, wherein the polyatomic anion comprises perchlorate.

17. (canceled)

18. (canceled)

19. (canceled)

20. (canceled)

21. The article as recited in claim 13, wherein the electrolyte solution is aqueous and acidic, wherein the metal cations comprise Cu and at least one of Bi or Li, wherein the transparent or translucent conductive electrode comprises a transparent conducting oxide electrode that comprises Pt nanoparticles.

22. (canceled)

23. (canceled)

24. (canceled)

25. (canceled)

26. (canceled)

27. The article as recited in claim 13, wherein the counter electrode comprises a same metal as a metal cation in the electrolyte solution.

28. The article as recited in claim 13, wherein the counter electrode comprises a different metal as compared to the metal cations in the electrolyte solution.

29. The article as recited in claim 13, wherein the article comprises a third electrode.

30. The article as recited in claim 13, wherein the electrolyte has a deposition voltage tolerance window of at least 0.2 V.

31. The article as recited in claim 13, wherein the electrochromic dynamic glass article darkens within 6 minutes of application of the cathodic potential.

32. The article as recited in claim 13, wherein the electrochromic dynamic glass article returns to its initially transparent or translucent condition within 6 minutes of reversing a polarity of an applied voltage.

33. The article as recited in claim 13, wherein the electrochromic dynamic glass article provides a contrast ratio of at least 30%, between darkened and lightened conditions.
